(19) United States
(12) Patent Application Publication
(10) Pub. No.: US 2016/0379407 A1
(43) Pub. Date: Dec. 29, 2016

(54) Virtual Fantasy System and Method of Use

(71) Applicant: Daryl Foster, Dayton, OH (US)

(72) Inventor: Daryl Foster, Dayton, OH (US)

(21) Appl. No.: 14/747,190

(22) Filed: Jun. 23, 2015

(51) Int. Cl. G06T 19/00; G06Q 30/06; H04N 13/02; G06F 3/01; G06F 3/16; G06K 9/00

(52) U.S. Cl. CPC G06T 19/006; G06F 3/167; G06K 9/00288; G06K 9/00315; H04N 13/0239; G06K 9/00255; G06K 9/00369; G06F 3/011; G06Q 30/0601

(57) ABSTRACT

A system for creating visual fantasy while engaging in a physical activity with a partner includes at least one eyewear piece provided with at one camera, a power source, a wireless transceiver, a visual display for receiving a video transmission, and a computer based device provided with virtual merging software for video data from said camera of the eyewear piece, wherein the virtual merging software can dynamically identify facial/body area data of a viewed person in video data, a database associated with the virtual merging software having predetermined facial character data of corresponding to another face and retrieves a predetermined facial/body character data based on a user predefined selection and manipulates the video data overlaying the selected predetermined facial/body character data into the facial area of the video data generating a merged field of view data and sends signal back to the visual display.

### FIELD OF INVENTION

The instant invention relates to the field of virtual reality. More particularly, the invention relates to a virtual fantasy system for enabling a virtual element to be inserted into a real image of environment, which is especially useful between sex partners.

### BACKGROUND OF INVENTION

The prior art has developed numerous devices for virtual reality experiences. Some of these include virtual goggles and avatar devices. These devices provide for interacting with a device to obtain a virtual reality. Some of these prior devices as it pertains to sex include use of structural devices which include dolls and other toys or hardware which can be used by the person in lieu of a physical partner.

For example, some of the devices are as follows. U.S. Pat. No. 6,695,770 B1 is directed to a simulated human interaction systems. The prior art discloses an apparatus providing a virtual reality sexual experience. The apparatus including audio reproduction means, visual reproduction means and tactile means for sexual stimulation. The apparatus further comprising a control system to correlate the audio means, visual means and tactile means to relate to one another to simulate a sexual experience. The apparatus being adapted for connection to a computer based drive system to provide a scenario for audio and visual outputs which is selected from a database and advances in a manner corresponding to user movements and engagement with the tactile system.

U.S. Pat. No. 5,980,256 discloses a virtual reality system with enhanced sensory apparatus which provides a motion simulating device wherein the user with full has freedom of motion. Ideally, the motion is coordinated with the user's senses. The motion simulating device may include a generally spherical capsule supported by a number of rollers, at least one of which is a multi-directional active roller which frictionally engages the spherical capsule. This causes the spherical capsule to rotate in any desired direction. The capsule may have mounted within it an interactive solid, which may take the form of an omni-directional treadmill for supporting the user.

US 20050014560 A1 discloses a method and system for simulating interaction with a pictorial representation of a model. The method and system displays video images associated with interaction with a still picture. For example, erotic movie sequences of a model may be accessed by a remote computer, to which a user transmits tactile-dependent signals that simulate sexual activity with the model. The remote computer transmits to a client computer one of the stored movie-sequences in accordance with the tactile-dependent signals for display by the client computer. The erotic picture is mounted on an appliance having at least one sensor, and a surface for disposing the picture thereon in registration with each sensor so that each sensor is accessible via a corresponding erogenous zone of the picture. The appliance is connected to the client computer for displaying an erotic movie-sequence based on tactile-dependent signals produced by stimulation of the respective sensors of the appliance via the corresponding erogenous zone of the picture. The prior art discloses a system displaying erotic images and video images for virtual reality display where head mounted display may also be employed.

WO 1999057900 A1 discloses a videophone with enhanced user defined imaging system. The improved videophone comprising an information transfer device permitting one or more users to communicate to one or more viewers while allowing the appearance, sound, motion, and characteristics of the individual users and the users' environments to be changed, replaced, augmented, modified, filtered, enhanced, or deleted. The improved videophone comprises an imaging system that acquires sensory information from the one or more users and/or the users' environments, and represents at least the essence of this information; a distribution channel that relocates the essential information from the users' locale to the viewers' locale; a presentation system that takes the essential information and creates for the one or more viewers a presentation that can change, replace, augment, modify, filter, enhance, and/or delete features, components, portions, and/or parts or wholes of the sensory appearances of the one or more users and the users' environments. The invention can be embodied using various imaging, distribution, and presentation technologies, in various connection topologies. The result can be used for a multitude of purposes, including such things as communication, entertainment, play etc. The prior art discloses an improved videophone for allowing a user to participate in a fantasy video with other actors in one-way casting of information.

US 20130095924 A1 discloses enhancing a sport using an augmented reality display. The personalized sport performance experience with three dimensional (3D) virtual data displayed by a near-eye, augmented reality display of a personal audiovisual (A/V) apparatus. A physical movement recommendation is determined for the user performing a sport based on skills data for the user for the sport, physical characteristics of the user, and 3D space positions for at least one or more sport objects. 3D virtual data depicting one or more visual guides for assisting the user in performing the physical movement recommendation may be displayed from a user perspective associated with a display field of view of the near-eye AR display. An avatar may also be displayed by the near-eye AR display performing a sport. The avatar may perform the sport interactively with the user or be displayed performing a prior performance of an individual represented by the avatar. The prior art embodies similar features like the current invention: as it discloses a head mounted display system for a 3D virtual data based personalized sport performance experience involving favorite celebrity as participant.

While all of the above provide significant advancements in the virtual field, there remains a need for improvements in the technology. Thus far the art has been primarily focused on self stimulation and there has not been provided an adequate system employing virtual technology in role playing during physical activity between the partners. The instant invention aims to enhance real sexual experience with their partner, wherein all physical contact is maintained, yet certain aspects are virtualized.

### SUMMARY OF INVENTION

It is an object to provide a system and method for creating a virtual fantasy while engaging in a physical activity.

It is an object to enhance sexual experiences with a partner.

Another object is to provide a visual fantasy with a partner employing a virtual overlay device.

A further object of the invention is to provide a system which includes a database of desired facial profiles which can be selectively employed by the users of the invention to create a virtual sexual experience with a partner which is cast with a selected facial profile.

Another object of the invention is to real-time cast a selected facial profile onto one or more of the partners and into a real environment in which the partners are participating.

A further object is to provide a social media website which integrates facial profiles (such as celebrities as well as non-celebrities) for selective use in a system which includes a database of desired facial profiles which can be selectively employed by users of the invention to create a virtual sexual experience with a partner which is cast with a selected facial profile.

Still a further object is to real-time cast a selected body profile onto one or more of the partners and into a real environment in which the partners are participating.

Accordingly, one aspect of the invention is directed to a system for creating visual fantasy with a partner. The system includes one or more employing a system for creating visual fantasy while engaging in a physical activity with a partner, which includes:

at least one eyewear piece, wherein each eyewear piece is provided with at least two cameras to provide a stereoscopic view, a power source, a wireless transceiver operably connected to the power source, a visual display operably integrated into the eyewear piece and for receiving a video transmission, and a computer based device provided with virtual merging software for receiving real field of view video data from the eyewear piece, wherein the virtual merging software is equipped for facial recognition and can dynamically identify facial/body area data of a viewed person in real time from the real field of view video data, a database associated with the virtual merging software is provided which includes predetermined facial body character data of corresponding to another face/body, wherein the virtual merging software retrieves a predetermined facial/body character data based on a user predefined selection from the database and upon receiving real field of view video data from one eyewear piece manipulates the real field of view video data overlaying the selected predetermined facial/body character data into the facial/body area of the real field of view video data creating a merged field of view data and sends a real time signal back to the one eyewear piece for display on the visual display.

The invention contemplates providing an audio device for obtaining, sending and receiving audio signals through the system. Thus, the user visually sees a real environment with only the viewed parties face being overlaid with a virtual dynamic image of his/her selected or desired facial character selected. Another aspect of the invention is to real-time cast a selected body profile onto one or more of the partners and into a real environment in which the partners are participating.

A web-based computer and social media site can thus be provided in which there are predetermined facial character(s) which can correlate to facial likeness of celebrities as well as non-celebrities. It is envisioned the invention includes the ability to charge for downloads of a particular facial character for use in the fantasy experience of the instant invention, wherein the party uploading such facial character data can set a download price. Subscribers of the website can select facial character data for rent or purchase.

The invention provides for real time modifying a live video image feed. Again, video feed is received which includes an image of a person's face. A processor locates facial feature data from the video feed by way of facial recognition software therein. Those facial feature data are selected and mirrored into the predetermined facial character data to provide a video feed having a virtual aspect on the real time viewed environment. Facial recognition software is equipped for determining facial expressions from the real field of view video data and mapping those expressions dynamically into the selected predetermined facial character data. An animation may be real time created to represent each real facial expression, such as a neutral facial expression, a surprised facial expression, an angry facial expression, and a smiling facial expression.

Another aspect of the invention is to real-time cast a selected body profile onto one or more of the partners and into a real environment in which the partners are participating. The virtual merging software retrieves a predetermined body character data based on a user predefined selection from the database and upon receiving real field of view video data from one eyewear piece manipulates the real field of view video data overlaying the selected predetermined body character data into a body area of the real field of view video data creating a merged field of view data and sends a real time signal back to the one eyewear piece for display on the visual display. The virtual merging software is equipped to cast a position of the body as a function of sensed position of the eyewear piece of the viewed partner.

The invention provides improvements over the existing technology. Other features and benefits of the invention will be apparent from reading the description and drawings which follow.

### BRIEF DESCRIPTION OF THE DRAWINGS

FIG. 1 is a block schematic diagram of an embodiment of the present invention.

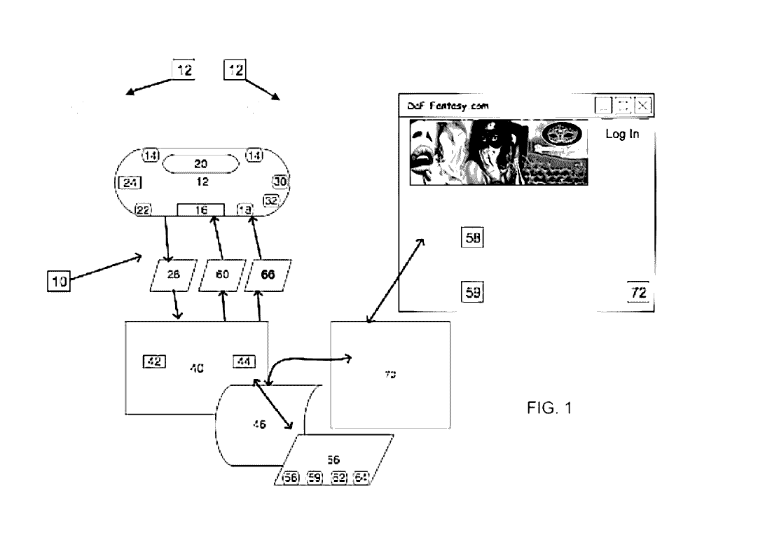

FIG. 2 is perspective view of eyewear of the instant invention.

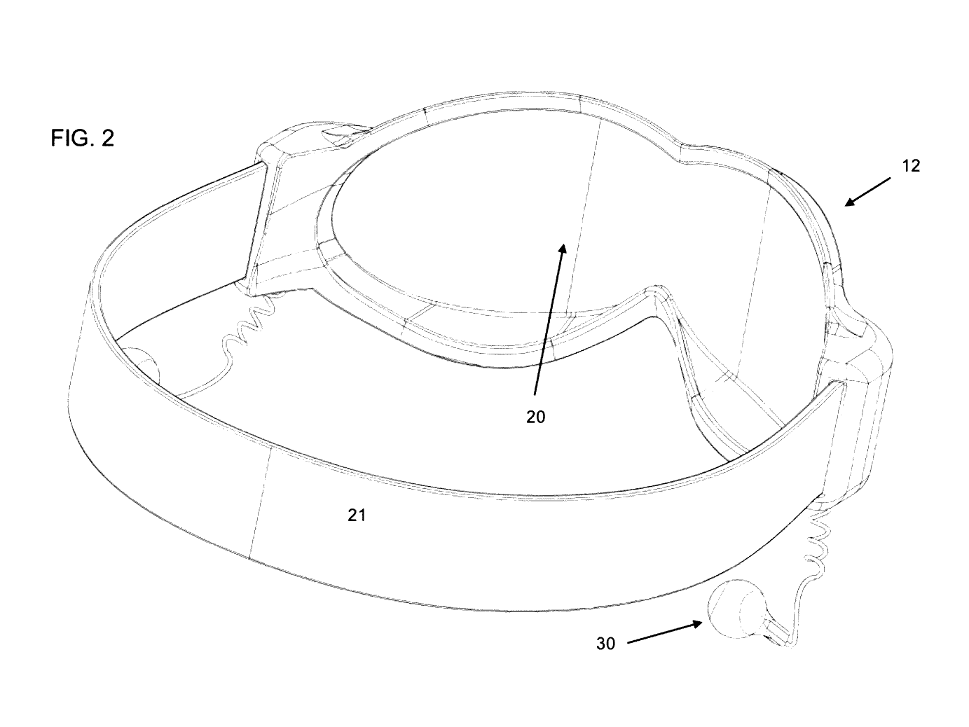

FIG. 3 is top view of eyewear of the instant invention.

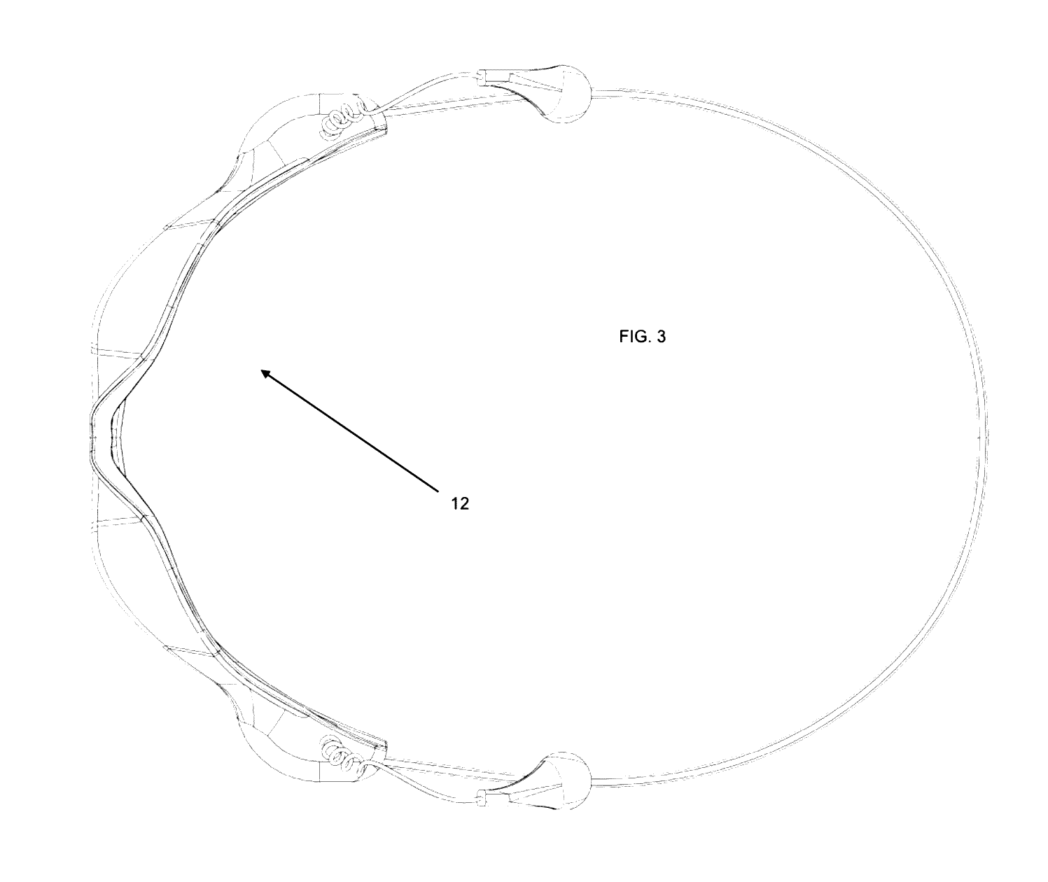

FIG. 4 is front view of eyewear of the instant invention.

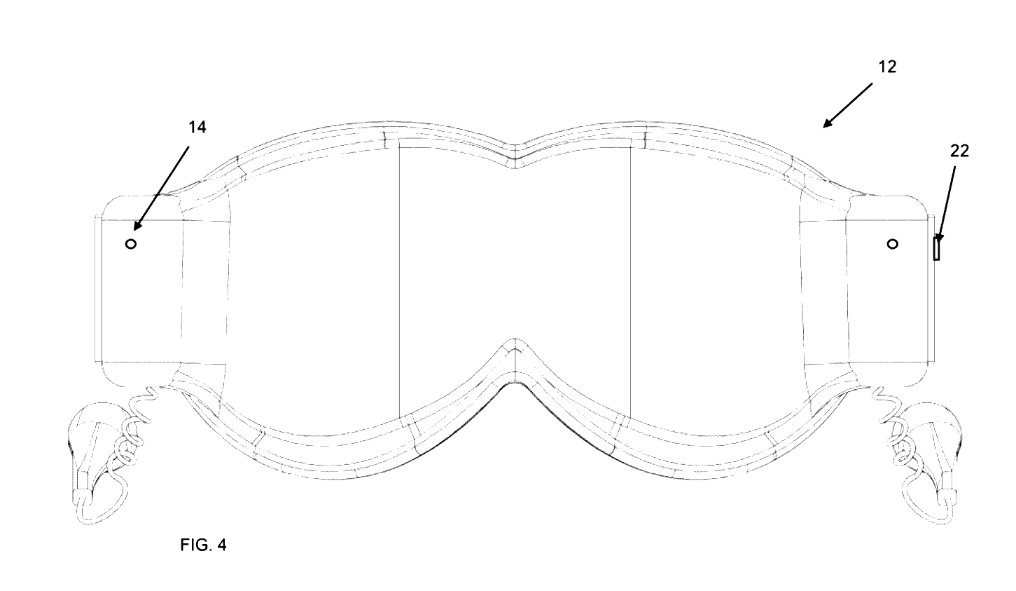

FIG. 5 is side view of eyewear of the instant invention.

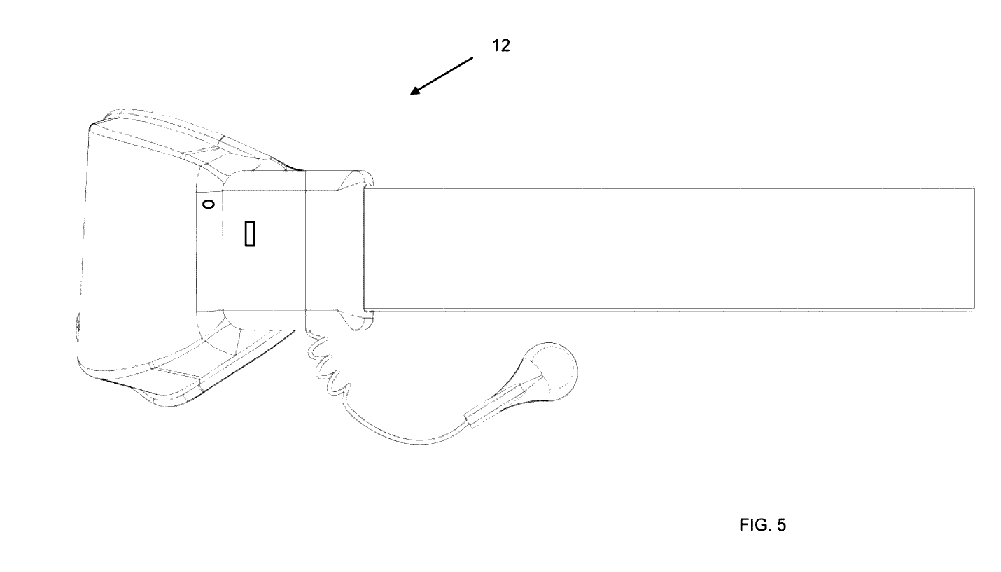

### DETAILED DESCRIPTION OF THE INVENTION

Referring now to the drawings, the virtual fantasy system and method are generally referred to by the numeral 10. The system 10 is envisioned to enable a visual fantasy with a partner, particularly during physical interaction, such as sexual activities. The system 10 includes one or more employing a virtual device on one or more partners, such as one or more eyewear pieces 12 worn by the partner(s) engaging in the physical experience with each other.

Each eyewear 12 is preferably provided with two cameras 14 to provide stereoscopic view and are operably connected to a power source 16, such as a rechargeable battery. Also, a wireless transceiver 18 is operably connected to the power source 16. A visual display 20 is operably integrated into the eyewear piece(s) 12 and can be held by a head band 21, for example. A power switch 22 can be provided on the eyewear pieces 12 which can be manual or wirelessly activated.

A microprocessor 24 can be provided operably on eyewear 12 and connects to cameras 14, power source 16, and transceiver 18. A local processor 40 equipped having broadband connectivity device for an Internet connection and integrated wireless device and can be provided at the wearer's site S for enabling transmission and receipt of data described herein.

The eyewear 12 provide for obtaining real field of view video data 28 (live image data) and transmitting real field of view video data 28. Additionally, there can be provided audio devices 30 integrated into the eyewear pieces 12 which can likewise transmit audio signal as part of real field of view video data 28.

Microprocessor 24 (e.g., electronic controller module) can be operably disposed in the eyewear pieces 12 for displaying video feed as will be described hereinafter. The microprocessor 24 is operably connected with visual display 20, power source 16 and cameras 14. It is contemplated the microprocessor 24 is equipped with a Wifi module and/or a Bluetooth module enabling electronic data transmission.

A motion sensor 32 can be operably connected to the microprocessor 24 for detecting motion and location of the eyewear 12 and further aid in the implementation of data overly so that virtual augmented reality video can be merged into the real image setting as described herein. In this regard, the motion sensor provides signal indicative of face and body orientation of the wearer. On/off control button 22 provided on the eyewear pieces 12 is for controlling power source 16 and energizing the eyewear pieces 12.

The visual display 20 includes two lenses located operably to a wearer's left and right eyes. 3D viewing can be accomplished using stereoscopic methods, wherein the retina of each eye receives a 2D projection of the 3D world from slightly different perspectives, from which the brain reconstructs a 3D experience with illusion of depth. Thus, stereoscopic is provided two offset images separately to the left and right eye of the viewer. These images are then combined in the brain to give the perception of 3D depth. Another technique envisioned is that the visual display provides an image in three full dimensions, one for each eye to create a 3D illusion.

Normally, what you see depends on in which direction you look. The invention uses motion sensors 32 of the eyewear pieces 12 track the head orientation and location on each user of the eyewear pieces 12 at the site S. The eyewear pieces 12 can include built-in sensors (gyroscope, magnetic compass, gravity sensor) can determine the orientation of your head. GPS and accelerometers can be provided to determine location. It is envisioned that as hardware technology improves, the way the visual data is viewed will be become more user friendly. By so doing, the software of the instant invention can overlay the particular selected facial (and/or body) data for the particular eyewear piece 12 as predetermined by the user and use to calculate what to display to the eyes of such user. With current technology, the visual display 20 is large enough such that if held horizontally about 5 cm from your eyes, the left/right eye can see the left/right half of the display which can include a ultra-strong (+20 dioptre) lens.

A wireless connection can be provided through which transmission and communication can be made through computer based device 40 (which is envisioned to be local or remote to site S and can incorporate processor 42). Virtual merging software 44 for receiving and sending video signal data and optionally audio transmission signal data. As real field of view video data 28 (and optional audio environment data) are received from the one or more eyewear pieces 12, the virtual merging software 44 is equipped with facial (and body) recognition and can dynamically identify facial area data of a viewed person in real time from the real field of view video data 28 (and optional audio environment data).

A database 46 is provided which includes dynamic attributes of predetermined facial character data 56. Virtual merging software 44 associated with the database 46 retrieves predetermined facial character data 58, 59, etc. based on a user predefined selection from the database 46. Upon receiving real field of view video data and optional audio environment data 28 from one eyewear piece 12, the virtual merging software 44 manipulates the real field of view video data and optional audio environment data 28 and overlays the same using predetermined facial character data 58, 59, etc. into the facial area of the real field of view video data and optional audio environment data 28 thus generating creating a merged field of view data signal 60 and transmitting a real time signal back to the one eyewear piece 12 for display on the visual display 20. The 3D position of the head and the features are adjusted from a frontal position to the actual position of the user/wearer as well as person viewed. For example, the wearer's face rotates his head and the virtual merging software 44 modifies the virtual facial data 60 with algorithms for adjustment in 3D on the fly. Thus, the user visually sees a real environment with only the viewed parties face being overlaid with a virtual dynamic image of his/her selected or desired facial character data, e.g., playmate.

Still another aspect of the invention is to provide virtual male and female character body data 62, 64 which permits the user to insert predetermined facial character data 58, 59, etc. into the facial area of virtual male and female character body data 62, 64. Virtual merging software 44 retrieves predetermined virtual male and female character body data 62, 64 based on a user predefined selection from the database 46. Upon receiving real field of view video data and optional audio environment data 28 from one eyewear piece 12, the virtual merging software 44 can manipulate the real field of view video data and optional audio environment data 28 and overlays the same using predetermined virtual male and female character body data 62, 64 into the body area of the real field of view video data and optional audio environment data 28 thus generating creating a merged field of view data signal 66 and transmitting a real time signal back to the one eyewear piece 12 for display on the visual display 20. Thus, the invention contemplates mixing and matching body and facial parts real time to simulate the body position and orientation depicted in the real field of view video data. The 3D position of the head and the features are adjusted from a frontal position to the actual position of the user/wearer as well as person viewed. For example, the wearer's face rotates his head and the virtual merging software 44 modifies the virtual facial data 60 and merged field of view data signal 66 and with algorithms for adjustment in 3D on the fly. Thus, the user can visually see a real environment with only the viewed parties face and or body being overlaid with a virtual dynamic image of his/her selected or desired facial character data or body, e.g., playmate.

A web-based computer 70 (which can be separate server or it is envisioned could be computer 40) is operably associated with the virtual merging software 44 and database 46. This provides another aspect of the instant invention which includes a social media site 72. The social media site 72 provides for a user/member interface 74 wherein a user/member can upload and download facial character data 56. Thus, there can be provided predetermined facial character(s) which can correlate to facial likeness of celebrities as well as non-celebrities. The social media site 72 provides a screen wherein a user/member can view from the database 46 particular facial character data based numerous criteria, including, sex, ethnicity, color, celebrity status, etc. with the ability to select and be charged for a rental session or downloads of a selected particular facial character for use in the fantasy experience of the instant invention. A party uploading a facial character data 58, 59, etc. (which can include a real or virtually created facial character data) can set a download price which upon purchase by a user/member/subscriber will be paid using existing technology known in the art. Subscribers of the website can select facial character data for rent or purchase and it is envisioned that the website can permit monthly or annual subscriptions for members.

In sum, the invention for real time modifying a live video image feed. A video feed is received which include an image of a person's face. The virtual merging software locates facial feature data from the real field of view video data and optional audio environment data by way of facial recognition software therein. Those facial feature data are selected and mirrored into the dynamic data attributes of a predetermined facial character to provide a video feed having a virtual aspect on the real time viewed environment. The facial recognition software includes the ability for determining facial expressions from a live video feed and mapping those expressions into the predetermined facial character data. An animation may be real time created to represent each real facial expression, such as a neutral facial expression, a surprised facial expression, an angry facial expression, and a smiling facial expression. It is envisioned that the system can employ web-based applications or reside at the location site S once the desired data is selected.

Unlike the prior art, the present invention is able to rapid video on the fly with minimal delay by employing the virtual merging software 44 and facial character database 46. This is possible because only certain features of the face are used in modifying the selected facial character selected and not the entire face thus embedding certain expressions of movements into the face. This limits the amount of processing necessary and increases the speed at which the morphing can be done.

As will be understood as those of skill in the art, the present invention could be embodied in variations, modifications and derivations without departing from the essential characteristics of the invention. Accordingly, reference should be made to the appended claims which set forth the scope of the claimed invention.

What is claimed is:

1. A system for creating visual fantasy while engaging in a physical activity with a partner, which includes:
at least one eyewear piece, wherein each eyewear piece is provided with at one camera, a power source operably connected to said camera, a wireless transceiver operably connected to said power source, a visual display operably integrated into said eyewear piece and for receiving a video transmission; and
a computer based device provided with virtual merging software for receiving real field of view video data from said camera of said eyewear piece, wherein said virtual merging software is equipped for facial recognition and can dynamically identify facial area data of a viewed person in real time from said real field of view video data, a database operably associated with said virtual merging software which includes predetermined facial character data of corresponding to another face, said virtual merging software retrieves a predetermined facial character data based on a user predefined selection from said database and upon receiving real field of view video data from said one eyewear piece manipulates, said real field of view video data overlaying said selected predetermined facial character data into said facial area of said real field of view data generating a merged field of view data and sends a real time signal back to said one eyewear piece for display on said visual display.

2. The system for creating visual fantasy while engaging in a physical activity with a partner of claim 1, which further includes an audio device operably connected to said eyewear for obtaining audio and sending audio signal data with said real field of view video data for use in creating said merged field of view data.

3. The system for creating visual fantasy while engaging in a physical activity with a partner of claim 1, which includes a web-based computer and social media website associated therewith which employs said database.

4. The system for creating visual fantasy while engaging in a physical activity with a partner of claim 3, wherein said predetermined facial character data correlate to facial likeness of one of celebrities and non-celebrities.

5. The system for creating visual fantasy while engaging in a physical activity with a partner of claim 3, wherein said website is equipped to enable ability to charge for a download of a particular facial character data for use in said instant invention.

6. The system for creating visual fantasy while engaging in a physical activity with a partner of claim 3, wherein said website is equipped to enable ability for a party uploading a facial character data to set a download price.

7. The system for creating visual fantasy while engaging in a physical activity with a partner of claim 3, wherein said website provides for subscribers of said website to select a facial character data for rent or purchase.

8. The system for creating visual fantasy while engaging in a physical activity with a partner of claim 3, wherein said virtual merging software provides real time modifying a live video image feed.

9. The system for creating visual fantasy while engaging in a physical activity with a partner of claim 1, which includes facial recognition software equipped for determining facial expressions from said real field of view video data and mapping those expressions dynamically into said selected predetermined facial character data.

10. The system for creating visual fantasy while engaging in a physical activity with a partner of claim 1, which is further characterized to include two cameras providing a stereoscopic view.

11. A system for creating visual fantasy while engaging in a physical activity with a partner, which includes:
at least one eyewear piece, wherein each eyewear piece is provided with at one camera, a power source operably connected to said camera, a wireless transceiver operably connected to said power source, a visual display operably integrated into said eyewear piece and for receiving a video transmission; and
a computer based device provided with virtual merging software for receiving real field of view video data from said camera of said eyewear piece, wherein said virtual merging software is equipped for one of facial and body recognition and can dynamically identify one of facial area and body area data of a viewed person in real time from said real field of view video data, a database operably associated with said virtual merging software which includes one of predetermined facial character data of corresponding to another face and predetermined body data of corresponding to another body, said virtual merging software retrieves one of a predetermined facial character data and predetermined body data based on a user predefined selection from said database and upon receiving real field of view video data from said one eyewear piece manipulates said real field of view video data overlaying at least one of sad selected predetermined facial character data and said predetermined body data into one of said facial area and body area of said real field of view data generating a merged field of view data and sends a real time signal back to said one eyewear piece for display on said visual display.

12. The system for creating visual fantasy while engaging in a physical activity with a partner of claim 11, which further includes an audio device operably connected to said eyewear for obtaining audio and sending audio signal data with said real field of view video data for use in creating said merged field of view data.

13. The system for creating visual fantasy while engaging in a physical activity with a partner of claim 11, wherein said predetermined facial character data correlate to facial likeness of one of celebrities and non-celebrities.

14. The system for creating visual fantasy while engaging in a physical activity with a partner of claim 11, which includes a website is equipped to enable ability to charge for a download of a particular facial character data for use in said instant invention.

15. The system for creating visual fantasy while engaging in a physical activity with a partner of claim 14, wherein said website is equipped to enable ability for a party uploading a facial character data to set a download price.

16. The system for creating visual fantasy while engaging in a physical activity with a partner of claim 14, wherein said website provides for subscribers of said website to select a facial character data for rent or purchase.

17. The system for creating visual fantasy while engaging in a physical activity with a partner of claim 14, wherein said virtual merging software provides real time modifying a live video image feed.

18. The system for creating visual fantasy while engaging in a physical activity with a partner of claim 11, which includes facial recognition software equipped for determining facial expressions from said real field of view video data and mapping those expressions dynamically into said selected predetermined facial character data.

19. The system for creating visual fantasy while engaging in a physical activity with a partner of claim 11, which is further characterized to include two cameras providing a stereoscopic view.
